(19) United States
(12) Patent Application Publication
(10) Pub. No.: US 2007/0002371 A1
(43) Pub. Date: Jan. 4, 2007

(54) Image Forming System

(75) Inventor: Shinji OHIRA, Mishima-shi (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Shinagawa-ku (JP)

(21) Appl. No.: 11/427,249

(22) Filed: Jun. 28, 2006

(30) Foreign Application Priority Data
Jun. 30, 2005 (JP) 2005-193150

(51) Int. Cl. G06F 3/12

(52) U.S. Cl. 358/1.15

(57) ABSTRACT

An external device judges whether or not a image forming is brought into an operation mode in which the number of pages having an image formed thereon is managed for each division, each user belonging to the division, in a image forming device, when the request for the image forming in the image forming device from a user is accepted. The external device confirms that a division code of the user who has requested the image forming is set, when it is judged that the image forming is brought into the operation mode in which the number of the pages is managed for each division, and transmits the request for the image forming together with the division code to the image forming device, when it is confirmed that the division code of the user who has requested the image forming is set.

### CROSS-REFERENCE TO RELATED APPLICATIONS

This application is based upon and claims the benefit of priority from prior Japanese Patent Application No. 2005-193150, filed Jun. 30, 2005, the entire contents of which are incorporated herein by reference.

### BACKGROUND OF THE INVENTION

1. Field of the Invention

The present invention relates to an image forming system including an image forming device such as a digital multifunction machine; and a computer as an external device which requests the image forming device to perform printing.

2. Description of the Related Art

Heretofore, among image forming devices such as a digital multifunction machine, there is a device having a function which manages the number of printed pages. In an image forming device such as the digital multifunction machine or a printer having a network communication function, there is assumed an operation mode in which the device is utilized by a large number of users. Among such image forming devices, there is a device having a function referred to as a division management function which manages the number of pages printed by each management unit referred to as a division.

In this division management function, a division counter set for each division counts the number of the pages printed for each division. The conventional division management function counts the number of the pages printed for each division regardless of the operation mode of the image forming device which has performed the printing. That is, in the conventional image forming device, in a state in which the division management function is effective, the number of all the printed pages is counted in the division counter set for each division as a management unit.

Therefore, in a case where the image forming device in which the division management function is set is requested to perform the printing from a terminal device such as a PC, in a conventional printer driver program, after a division code is checked in the PC, the division code having its validity confirmed is transmitted together with the printing request to the image forming device. Therefore, the user needs to surely input a correct division code regardless of printing mode.

Moreover, in the conventional printer driver program, the printing request can be transmitted without checking any division code in the PC. Therefore, if the division code designated by the PC is invalid, the printing request transmitted from the PC to the image forming device is brought into a pending state in the image forming device. In such case, in the conventional system, the user needs to input the correct division code directly into the image forming device.

### BRIEF SUMMARY OF THE INVENTION

In one aspect of this invention, an object is to provide an image forming control method, a program for an image forming control and an image forming system in which user convenience or operability can be improved.

An image forming control method as one aspect of this invention is used in a system in which an image forming device is connected to an external device, and the method: accepts, from a user in the external device, a request for image forming in the image forming device; judges whether or not the image forming is brought into an operation mode in which the number of pages having an image formed thereon is managed for each division, each user belonging to the division, in the image forming device, in a case where the request for the image forming in the image forming device is accepted; confirms in the external device that a division code of the user who has requested the image forming is set, in a case where the judgment is that the image forming is brought into the operation mode in which the number of the pages is managed for each division; and transmits the request for the image forming together with the division code from the external device to the image forming device, in a case where the confirmation confirms that the division code of the user who has requested the image forming is set.

A program for an image forming control as another aspect of this invention is a program for use in a computer connected to an image forming device, and has: an accepting function which accepts, from a user, a request for image forming in the image forming device; a judging function which judges whether or not the image forming is brought into an operation mode in which the number of pages having an image formed thereon is managed for each division, each user belonging to the division, in the image forming device, in a case where the accepting function accepts the request for the image forming in the image forming device; a confirming function which allows the external device to confirm that a division code of the user who has requested the image forming is set, in a case where the judging function judges that the image forming is brought into the operation mode in which the number of the pages is managed for each division; and a transmitting function which transmits the request for the image forming together with the division code from the external device to the image forming device, in a case where the confirming function confirms that the division code of the user who has requested the image forming is set.

An image forming system as still another aspect of this invention is a system including: an image forming device; and an external device connected to the image forming device, the external device including: an accepting unit which accepts, from a user, a request for image forming in the image forming device; a judging unit to judge whether or not the image forming is brought into an operation mode in which the number of pages having an image formed thereon is managed for each division, each user belonging to the division, in the image forming device, in a case where the accepting unit accepts the request for the image forming in the image forming device; a confirming unit which allows the external device to confirm that a division code of the user who has requested the image forming is set, in a case where the judging unit judges that the image forming is brought into the operation mode in which the number of the pages is managed for each division; and a transmitting unit which transmits the request for the image forming together with the division code from the external device to the image forming device, in a case where the confirming unit confirms that the division code of the user who has requested the image forming is set, the image forming device including: a printer which performs the image forming in response to the request for the image forming from the external device.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram schematically showing a constitution example of an image forming system in an embodiment of the present invention;

FIG. 2 is a block diagram schematically showing a constitution example of a digital multifunction machine;

FIG. 3 is a block diagram schematically showing a constitution example of a client PC;

FIG. 4 is a diagram showing an example of operation setting information of a printer driver;

FIG. 5 is a diagram showing a display example of a setup screen which sets basic particulars in print processing;

FIG. 6 is a diagram showing a display example of a job type screen which sets a printing function in a MFP 1 as a printer;

FIG. 7 is a diagram showing a display example of a warning dialog in a case where it is judged by division code check that a division code is ineffective;

FIG. 8 is a flowchart showing an operation example of the printer driver;

FIG. 9 is a flowchart showing a processing example of printing set processing; and

FIG. 10 is a flowchart showing a processing example of the division code check.

### DETAILED DESCRIPTION OF THE INVENTION

An embodiment for carrying out this invention will be described hereinafter with reference to the drawing.

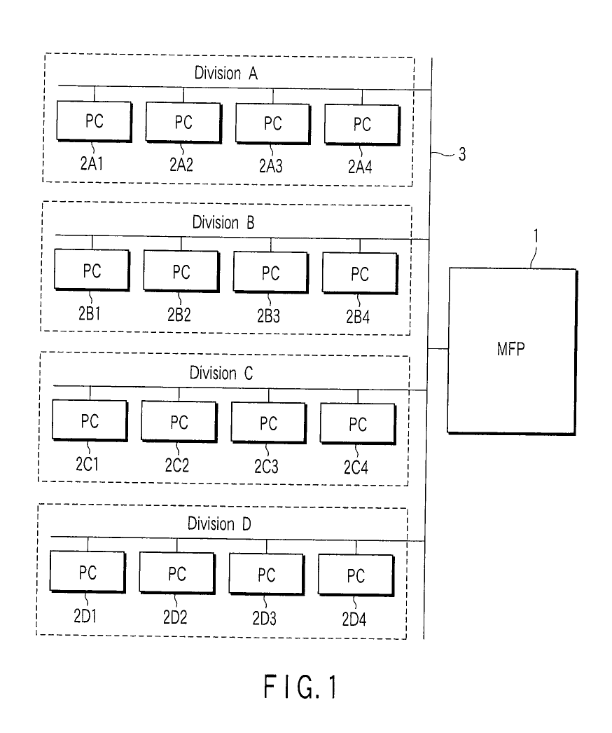

FIG. 1 is a diagram showing a schematic constitution of an image forming system in the embodiment of this invention.

As shown in FIG. 1, in this image forming system, a digital multifunction machine (multifunction peripheral [MFP]) 1 as an image forming device is connected to a plurality of client PCs 2 (2A1 to 2A4, 2B1 to 2B4, 2C1 to 2C4 and 2D1 to 2D4) by a network 3 such as a local area network (LAN).

The MFP 1 mainly has a printer function, a scanner function, a photocopying function, a facsimile transmitting and receiving function and the like. The MFP 1 has a function which processes a color image and a function which processes a monochromatic image. That is, the MFP 1 has: a color scanning function which chromatically reads an image of a draft; a monochromatic scanning function which monochromatically reads the image of the draft; a color printing function which forms a color image on an image forming medium; and a monochromatic printing function which forms a monochromatic image on the image forming medium. Accordingly, the MFP 1 realizes color photocopy and monochromatic photocopy as the photocopying function, and realizes color print and monochromatic print as the printer (network printing) function. It is to be noted that as the facsimile receiving function, the monochromatic print is performed.

Each client PC (hereinafter also referred to simply as a PC) 2 has a network interface communicating function which performs data communication via the network 3. In the PC 2, there is installed a printer driver which requests the MFP 1 to perform printing via the network 3. In the function which requests the MFP 1 to perform the printing, each PC 2 allows the printer driver to request the MFP 1 to print a color image or a monochromatic image. For example, when the PC 2 requests the MFP 1 to print the color image, the peripheral allows the network printing function to perform the color print based on the printing request received from the PC 2. When the PC 2 requests the MFP 1 to print the monochromatic image data, the peripheral allows the network printing function to perform the monochromatic print based on the printing request received from the PC 2.

Moreover, it is assumed that the PCs 2 (2A1 to 2A4, 2B1 to 2B4, 2C1 to 2C4 and 2D1 to 2D4) are assigned to the users divided into groups referred to as divisions, respectively. Here, a division refers to the group to which each user having each PC 2 assigned thereto belongs. In an organization such as a company, it is assumed that a department, a section or the like as a place to which each of a plurality of users belongs corresponds to a division.

In a constitution example shown in FIG. 1, it is indicated that a plurality of PCs 2A1 to 2A4 are used by the users who belong to a division A. In FIG. 1, it is also indicated that a plurality of PCs 2B1 to 2B4 are used by the users who belong to a division B. It is further indicated in FIG. 1 that a plurality of PCs 2C1 to 2C4 are used by the users who belong to a division C. It is further indicated in FIG. 1 that a plurality of PCs 2D1 to 2D4 are used by the users who belong to a division D.

Next, there will be described a constitution of a control system of the MFP 1.

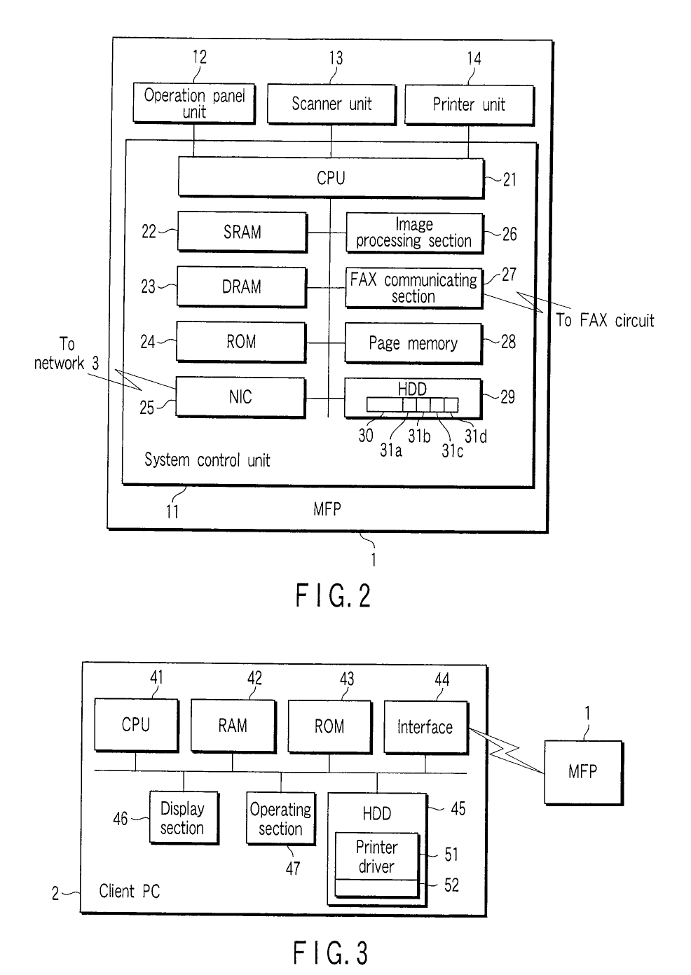

FIG. 2 is a block diagram showing a constitution example of the control system of the MFP 1.

As shown in FIG. 2, this MFP 1 is constituted of a system control unit 11, an operation panel 12, a scanner unit 13, a printer unit 14 and the like.

The system control unit 11 controls the whole MFP 1. The system control unit 11 is connected to the operation panel 12, the scanner unit 13, the printer unit 14 and the like. Accordingly, the system control unit 11 accepts an operation instruction input into the operation panel 12, controls the scanner unit 13, or controls the printer unit 14. In addition to the function which controls the scanner unit 13 and the printer unit 14, the system control unit 11 also has functions which perform various types of processing such as network communication control, facsimile transmission and reception, division (or user) authentication, data management, image judgment and image correction.

The operation panel 12 is a user interface. The operation panel 12 is constituted of hardware keys (not shown), a display device (not shown) containing a touch panel and the like. The operation panel 12 displays operation guidance and the like, and an operation instruction is input. Settings of various types of functions, setting information and the like are input by the operation panel 12.

The scanner unit 13 converts the draft image into image data. The scanner unit 13 converts the draft image into chromatic or monochromatic digital image data. The scanner unit 13 is constituted of: a scanning section (not shown) which optically scans a draft face; a photoelectric converting section (not shown) such as a CCD line sensor which converts, into an electric signal, reflected light from the draft face optically scanned by the scanning section and the like. The scanner unit 13 supplies the digital image data as the read draft image to the system control unit 11.

The printer unit 14 forms the image on the image forming medium. The printer unit 14 has: a color printing function which forms a color image on the image forming medium based on the color image data; and a monochromatic printing function which forms a monochromatic image on the image forming medium based on the monochromatic image data. The printer unit 14 is constituted of: a conveying section (not shown) which conveys the image forming medium; an image forming section (not shown) which forms the color image or the monochromatic image on the image forming medium conveyed by the conveying section and the like. The printer unit 14 prints the image data of each page on the image forming medium based on the control performed by the system control unit 11.

Moreover, the system control unit 11 is constituted of: a central processing unit (CPU) 21; a static random access memory (SRAM) 22; a dynamic random access memory (DRAM) 23; a read only memory (ROM) 24; a network communicating section 25; an image processing section 26; a facsimile (FAX) communicating section 27; a page memory 28; a hard disk drive (HDD) 29 and the like.

The CPU 21 controls the whole system control unit 11. The CPU 21 operates based on a control program to perform various types of processing. The CPU 21 is connected to the operation panel 12, the scanner unit 13, the printer unit 14 and the like.

The SRAM 22 is backed up by a battery (not shown), and used as a memory which stores system setting information and the like. Data for changing and the like are stored in the SRAM 22. For example, a counter value of the number of the pages printed by a division management function described later is counted up in a counter set in the SRAM 22.

The DRAM 23 is a memory which temporarily stores data for operation or stores data to be referred to. The DRAM 23 is used as a main memory. In a case where, for example, the system setting information and the like are referred to from the outside, the information stored in the DRAM 23 is referred to.

The ROM 24 is a nonvolatile memory. In the ROM 24, there are stored, for example, the control program, control data and the like for controlling the MFP 1. The network communicating section 25 controls data communication via the network 3. The network communicating section 25 is constituted of a network interface card (NIC) to be connected to the network 3 and the like. In the network communicating section 25, a network printer function receives a request for printing the printing image data and the like from each PC 2 via the network 3.

The image processing section 26 subjects the image data to various types of image processing. The image processing section 26 is constituted of an image processing circuit and the like. The image processing section 26 performs image processing such as correction, compression or expansion of the image data. The facsimile communicating section 27 is an interface which transmits and receives facsimile data. For example, facsimile reception processing is realized by monochromatically printing, by the printer unit 14, facsimile data received by the facsimile communicating section 27, and facsimile transmission processing is realized by converting the draft image data read by the scanner unit 13 into facsimile data, and transferring the data to a destination by the facsimile communicating section 27.

The page memory 28 is a memory having at least a storage region to develop the image data for one page to be printed by the printer unit 14. The page memory 28 is controlled by a page memory controller (not shown). For example, in a case where the printer unit 14 performs the print processing, in the page memory 28, there is developed (stored) the color image data or the monochromatic image data of each page to be printed by the printer unit 14.

The HDD 29 is a large-capacity storage device. The HDD 29 is also used as a memory for backup of various types of data, and various types of setting data or management data are stored. In the HDD 29, there is stored data received via the network 3, the image data read by the scanner unit 13 or the like, if necessary. In the present embodiment, in the HDD 29, there is stored division management information such as a division code corresponding to a division constituting a management object of the division management function described later.

Moreover, the HDD 29 is provided with: a division undefined counter 30 in which the corresponding division is not defined; a division counter 31 (31a, 31b, 31c and 31d) for each division constituting the management object of the division management function as the division management means and the like. The division undefined counter 30 is a counter which is not associated with any specific division (a counter in which the division is not defined). The division counters 31a, 31b, 31c and 31d are counters associated with the divisions as the management objects, respectively, by the division management function.

It is to be noted that in the constitution example shown in FIG. 2, there is assumed a case where, as shown in FIG. 1, the divisions A, B, C and D are set as the divisions constituting the management objects of the MFP 1. Therefore, in the MFP 1, the divisions A, B, C and D are set as the management objects of the division management function described later. In this case, in the HDD 29, there are stored division management information such as the division codes corresponding to the divisions A, B, C and D, and there are arranged the division counters 31a, 31b, 31c and 31d associated with the divisions A, B, C and D as the divisions constituting the management objects. That is, the division counter 31 is set for each division constituting the management object of the division management function of the MFP 1.

Next, there will be described a constitution of each client PC 2.

FIG. 3 is a block diagram showing a constitution example of each client PC 2.

As shown in FIG. 3, each client PC 2 is constituted of a CPU 41, an RAM 42, an ROM 43, a network interface (I/F) 44, a hard disk drive (HDD) 45, a display section 46, an operating section 47 and the like.

The CPU 41 controls the whole client PC 2. The CPU 41 executes a control program stored in the ROM 43 or an application program stored in the HDD 45 to realize various functions. The RAM 42 is a memory which temporarily stores data for operation and the like. The ROM 43 is a nonvolatile memory in which there are stored beforehand a basic control program for the client PC 2 to operate and the like.

The network interface 44 is an interface for performing data communication with the external device via the network 3. The network interface 44 functions as an interface which requests the MFP 1 to perform printing via the network 3.

The HDD 45 is a storage device constituted of a magnetic disk and the like. In the HDD 45, various types of data are stored in a file form. In the HDD 45, there are stored at least a printer driver program (also referred to simply as a printer driver) 51 for using the MFP 1 as a printer, operation setting information 52 for using the MFP 1 as the printer and the like.

The display section 46 is constituted of a display and the like. In the display section 46, an operation guidance or the like is displayed. The operating section 47 is constituted of a pointing device such as a keyboard or a mouse and the like. The operating section 47 is a user interface of the PC 2 to be operated by the user.

Next, there will be described the color print and the monochromatic print in the MFP 1 constituted as described above.

The MFP 1 has a monochromatic printing mode and a color (full color) printing mode. The monochromatic printing mode handles an image of a printing object as the monochromatic image, and monochromatically prints the image on the image forming medium. The color printing mode handles the image of the printing object as the color image, and chromatically prints the image on the image forming medium.

Moreover, the MFP 1 as the network printing function selectively executes the color print or the monochromatic print in response to a printing request from each PC 2. In the MFP 1, it is assumed that a series of print processing is managed by a unit referred to as a printing job. The MFP 1 manages, as one printing job, the print processing in response to one printing request received by the network printing function.

Next, there will be described the division management function of the MFP 1.

The division management function of the MFP 1 is a function which manages the number of printed pages as the use results of the MFP 1 for each division. For example, in the image forming system shown in FIG. 1, the division management function of the MFP 1 manages the number of the pages printed for each division or limits the number of printable pages for each division. It is to be noted that the division management function is set to be effective or ineffective by an operation of the operation panel 12.

Moreover, in the HDD 29 or the like, there is stored division management information (information such as the division code and the division counter) on the division as a management object of the division management function. That is, the division to be managed by the division management function is set beforehand as the division management information associated with the division code for identifying the division. As the division management information, there is also defined (set) the division counter 31 associated with the division code. The division counter 31 is a counter which counts the number of the pages printed for each division.

For example, in the image forming system shown in FIG. 1, the divisions constituting the management objects are the divisions A, B, C and D. In this case, unique division codes are set to the divisions (divisions A, B, C and D), respectively. In a case where the thus set division management function is effective, the MFP 1 identifies the division to which the user belongs based on the division code designated by the user.

Moreover, assuming that the color management function described later is ineffective, in a case where the network printing function is utilized in a case where the division management function is effective, the user operates each PC 2 to designate the image data for printing and the division code to which the user belongs. In this case, the PC 2 transmits the printing request including the image data for printing and the division code to the MFP 1 via the network 3.

On receiving the printing request from the PC 2 via the network 3, the MFP 1 authenticates the division of the user based on the division code included in the received printing request and the division code as the division management information set beforehand. When the user's division is identified in this manner, the MFP 1 executes the print processing based on the received image data for printing, and allows the division counter 31 to count the number of the pages printed during the print processing as the use results of the identified division.

Next, there will be described a color management (management for color only) function to be performed in a case where the division management function is effective.

The MFP 1 has the color management (management for color only) function which manages only the number of the chromatically printed pages for each division, when the division management function is effective. This color management function is a function which counts only the number of the chromatically printed pages for each division in the division management function. In other words, the color management function is a function (a function which does not manage the monochromatic print for each division) which does not count the number of monochromatically printed pages in the division counter.

In the MFP 1 having a state in which the above color management function is effective, the number of the monochromatically printed pages is not regarded as the management object, and only the number of the chromatically printed pages is managed. That is, in a state in which the color management function is effective, the number of the chromatically printed pages is counted in the division counter 31 disposed for each division, and the number of the monochromatically printed pages is counted in the division undefined counter 30. As a result, when the color management function is effective, the monochromatic print is limitlessly performed even in a state in which the division is not identified.

In general, in the monochromatic print, consumption of a developer such as toner, a photosensitive member or the like is small, and cost is small as compared with the color print. The monochromatic print is utilized in performing miscellaneous daily printings in many cases. In such a situation, there is a case where no restriction is imposed on the monochromatic print, and only the color print is requested to be managed. In such a case, the above color management function allows the monochromatic print to be limitlessly performed, and only the use results of the color print can be managed.

Next, there will be described a function of the printer driver 51 of the above client PC 2.

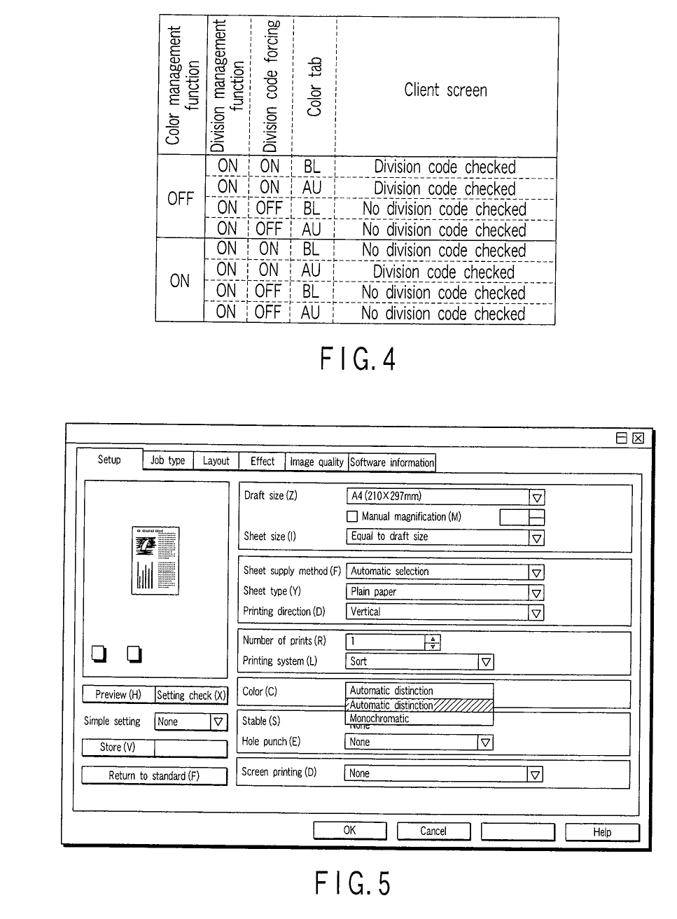

FIG. 4 is a diagram showing an example of the operation setting information 52 of the printer driver 51. The printer driver 51 realizes functions shown in FIG. 4. Here, a division code forcing function is a function which allows the printer driver 51 to check validity of the division code in a state in which the division management function is effective.

In the operation setting information 52 shown in FIG. 4, in a case where the division management function is effective (ON), and the color management function is ineffective (OFF), the printer driver 51 checks the division code in accordance with the division code forcing function.

That is, in a case where the division management function is effective (ON), the color management function is ineffective (OFF) and the division code forcing function is effective (ON), the printer driver 51 checks the division code regardless of the setting state of color designation. In this case, as the printing request to the MFP 1 as the printer, the printer driver 51 transmits the printing image data together with the division code which has been checked as a valid division code.

Moreover, in a case where the division management function is effective (ON), the color management function is ineffective (OFF) and the division code forcing function is ineffective (OFF), the printer driver 51 does not check any division code regardless of the setting state of the color designation. In this case, as the printing request to the MFP 1 as the printer, the printer driver 51 transmits the printing image data together with the division code which does not have any validity checked. It is to be noted that in this case, the validity of the division code is exerted at a time when the MFP 1 receives the printing request. Therefore, when the division code is invalid, the printing request becomes pending in the MFP 1. This pending printing request is executed, for example, when the user inputs the valid division code into the operation panel of the MFP 1.

Furthermore, in a case where the division management function is effective (ON) and the color management function is effective (ON), the printer driver 51 does not check any division code regardless of the setting state of the division code forcing function, when the monochromatic printing is designated.

That is, in a case where the division management function is effective (ON), the color management function is effective (ON) and the division code forcing function is effective (ON), the printer driver 51 does not check any division code, when the monochromatic printing is designated. In this case, as the printing request to the MFP 1 as the printer, the printer driver 51 transmits the printing image data without any division code (or together with the division code which is not checked).

Moreover, in a case where the division management function is effective (ON), the color management function is effective (ON) and the division code forcing function is effective (ON), the printer driver 51 checks the division code, when the monochromatic printing is not designated. In this case, as the printing request to the MFP 1 as the printer, the printer driver 51 transmits the printing image data together with the division code which has been checked as the valid division code.

Furthermore, in a case where the division management function is effective (ON), the color management function is effective (ON) and the division code forcing function is ineffective (OFF), the printer driver 51 does not check any division code regardless of the color designation. This is similar to a case where the color management function is ineffective (OFF). In this case, as the printing request to the MFP 1 as the printer, the printer driver 51 transmits the printing image data without any division code (or together with the division code which has not been checked).

Next, there will be described print setting by the printer driver 51.

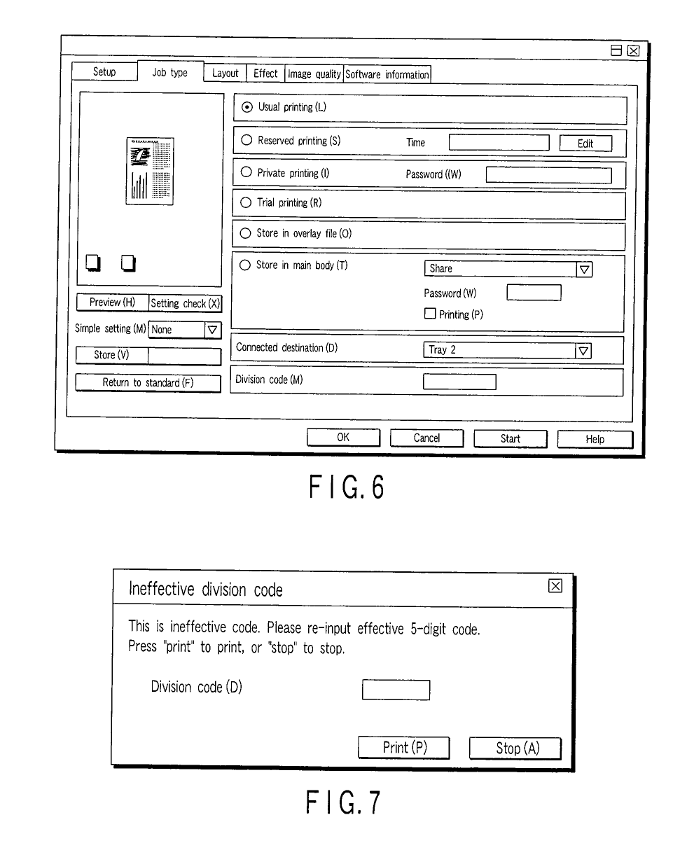

In the printer driver 51, the user selects various print setting items, or inputs setting information to set the information in various setting screens described later. FIGS. 5 and 6 show display examples of a setting screen displayed in the display section 46 of the PC 2. FIG. 5 shows a display example of a setup screen which sets basic particulars in the print processing. FIG. 6 shows a display example of a job type screen which sets a printing function in a MFP 1 as the printer. In the display examples shown in FIGS. 5 and 6, various tabs are displayed in an upper portion of the screen in order to switch the setting screen. When one of these tabs is selected in the operating section 47, the setting screen is switched in the display section 46.

The setup screen shown in FIG. 5 is displayed in the display section 46, when a displayed “setup” tab is selected in various types of setting screens. The display example shown in FIG. 5 indicates a state in which the “setup” tab is selected. In the setup screen shown in FIG. 5, there are arranged setting display columns for selecting: a draft size; a sheet size; a sheet supply method; a sheet type; a sheet direction; the number of printed pages; a printing system; a color mode; the presence of stapling; the presence of hole punching; and the presence of double-sided printing. In a lower portion of the setup screen, there are displayed operation keys such as “OK”, “cancel”, “apply” and “help”. Furthermore, in a left portion of the setup screen, there are arranged a preview screen of the image to be printed, a “return to standard” key for returning set contents to default setting and the like.

In the setup screen shown in FIG. 5, a color mode is an item for designating whether or not the image to be printed is monochromatic. As shown in FIG. 5, when a left mark of the setting display column of the color mode is indicated, a selection window is displayed in order to select “automatic distinction” or “monochromatic”. In this selection window, the user operates the operating section 47 to select “automatic distinction” or monochromatic.

In the above, “automatic distinction” is a mode which automatically judges that the printing image data is monochromatic or chromatic. It is assumed in the example shown in FIG. 5 that “automatic distinction” is selected even for the printing of the color image. Here, it is assumed in “automatic distinction” that the MFP 1 as the printer judges from the printing image data whether the printing is chromatic or monochromatic. Moreover, “monochromatic” is a mode which designates that the printing image data is monochromatically printed. Therefore, in a case where “monochromatic” is selected, the MFP prints the printing image data from the PC 2 in the monochromatic printing mode.

The job type screen shown in FIG. 6 is displayed in the display section 46, when a displayed “job type” tab is selected in various types of setting screens. The display example shown in FIG. 6 indicates a state in which the “job type” tab is selected. In the job type screen shown in FIG. 6, in an upper right region above the center of the screen, there is displayed a selection screen to select functions such as usual printing, reserved printing, private printing, trial printing, storing in an overlay file and storing in a main body. Further in the job type screen shown in FIG. 6, in a lower right region below the center of the screen, there is displayed a designation screen for designating a connected destination and a division code. In a lower portion of the job type screen, there are displayed operation keys such as “OK”, “cancel”, “apply” and “help”. Furthermore, in a left portion of the job type screen, there are arranged a preview screen of the image to be printed, a “return to standard” key for returning set contents to default setting and the like.

In the job type screen shown in FIG. 6, the division code to be designated by the user is displayed in a display column of the division code. In the division code display column shown in FIG. 6, the user operates the operating section 47 to directly input the division code. That is, in the division code display column shown in FIG. 6, the division code input by the user is displayed. The division code to be displayed in the division code display column may be input every time the printing request is made, or may be retained as long as there is not any user's instruction for change.

Moreover, FIG. 7 is a diagram showing a display example of a warning screen to be displayed in a case where it is judged by the division code check that the division code is ineffective.

In the warning screen shown in FIG. 7, in a case where the division code check judges that the designated division code is ineffective (invalid), a popup screen is displayed as a warning dialog in the display screen of the display section 46. In the warning screen shown in FIG. 7, it is indicated that the designated (set) division code is an ineffective code, and there is displayed a guidance indicating that the effective division code is to be input again.

Furthermore, in the display example of the warning screen shown in FIG. 7, there is also displayed an input column for inputting the division code. In the display example of the warning screen shown in FIG. 7, a printing key and a stop key are displayed in a lower portion of the screen. The printing key is selectable in a case where the code which seems to be valid (e.g., digit number is correct) is input into an input column. Therefore, in a case where the warning screen shown in FIG. 7 is displayed, to execute the printing, the user inputs a correct division code into the division code input column to indicate the printing key. When the division code is input to indicate the printing key, the printer driver 51 checks the division code input into the input column. When it is confirmed that the input division code is correct, the printing request is started.

Next, there will be described an operation of the printer driver 51 installed in the client PC 2.

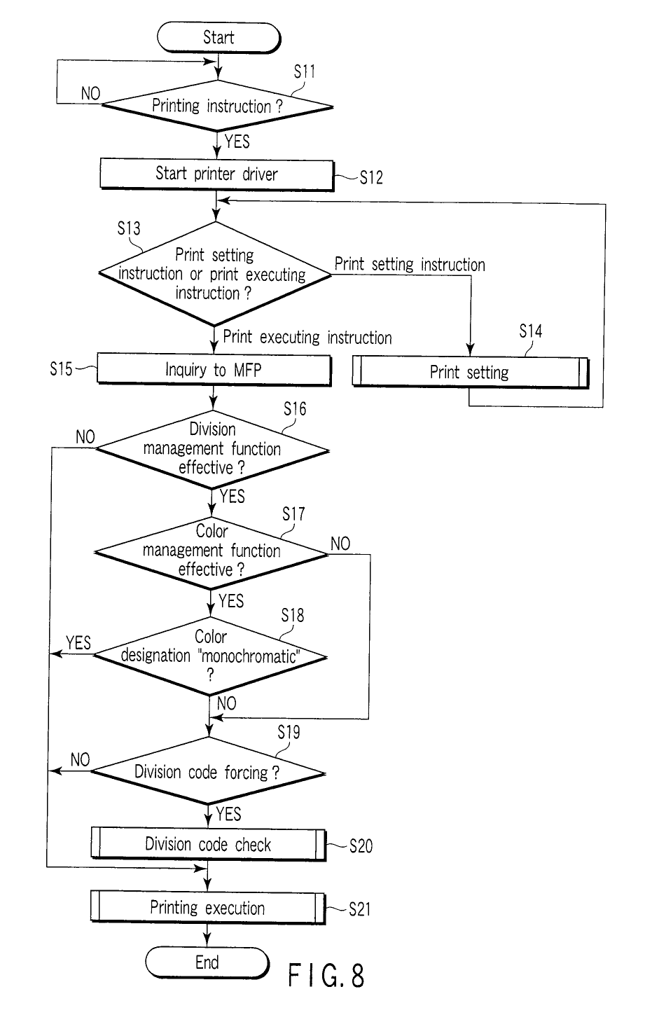

FIG. 8 is a flowchart showing an operation example of the printer driver 51.

When the user instructs the printing in the client PC 2 (step S11, YES), the printer driver 51 is started (step S12). It is to be noted that the following processing is a function realized by the printer driver 51.

When the printer driver 51 is started in response to the user's printing instruction, the CPU 41 of the client PC 2 displays in the display section 46 a printing instruction screen (not shown) for executing the printing. In this printing instruction screen, the user instructs the execution of the printing or the setting of the printing. Here, in a case where the user instructs the setting of the printing (step S13, print setting instruction), the CPU 41 displays a setting screen for setting various printing functions presented by the printer driver 51, and performs the printing set processing (setting change processing) (step S14).

In this printing set processing, for example, the setup screen shown in FIG. 5, the job type screen shown in FIG. 6 or the like is displayed as the setting screen in the display section 46, and the contents input in a state in which the screen is displayed are set as print setting. It is to be noted that the printing set processing will be described later in detail.

When the printing set processing ends, the CPU 41 displays the printing instruction screen in the display section 46. Then, the user instructs the execution of the printing in the printing instruction screen. When the execution of the printing is instructed (step S13, print executing instruction), the CPU 41 makes an inquiry as to the setting states of the division management function, the color management function and the like with respect to the MFP 1 as the printer (step S15). The CPU 41 judges the setting states of the division management function, the color management function and the like in the MFP 1, by a response from the MFP 1 with respect to this inquiry.

On receiving, from the MFP 1, notice of the setting states of the division management function, the color management function and the like, the CPU 41 first judges whether or not the division management function of the MFP 1 is brought into an effective state (step S16). In a case where this judgment is that the division management function is ineffective (step S16, NO), the CPU 41 transmits the printing request including the printing image data (step S21). Accordingly, the PC 2 can allow the MFP 1 to execute the print processing which is not the object of the division management without any input of the division code from the user.

Moreover, in a case where the above judgment is that the division management function is effective (step S16, YES), the CPU 41 further judges that the color management function of the MFP 1 is effective (step S17). In a case where this judgment is that the color management function is ineffective (step S17, NO), the CPU 41 further judges whether or not the division code forcing function is effective (step S19).

In a case where this judgment is that the division code forcing function is ineffective (step S19, NO), the CPU 41 judges that any division code is not checked based on the operation setting information 52. That is, in a case where it is judged that the division management function is effective, the color management function is ineffective and the division code forcing function is ineffective, the CPU 41 requests the printing regardless of the color designation without checking any division code. In this case, as described above, as the printing request to the MFP 1 as the printer, the CPU 41 transmits the printing image data together with the division code which does not have its validity checked (step S21). Accordingly, the PC 2 can allow the MFP 1 to execute the print processing which is the object of the division management.

It is to be noted that in this case, the MFP which has received the printing request checks the division code included (or to be included) in the printing request. In a case where the check in the MFP 1 judges that the division code is invalid, the printing request turns to a pending printing job in the MFP 1. This pending printing job is executed, for example, when the user operates the operation panel 12 of the MFP 1 to input the valid division code.

Moreover, in a case where the above judgment is that the division code forcing function is effective (step S19, YES), the CPU 41 judges that the division code check be performed based on the operation setting information 52. That is, in a case where it is judged that the division management function is effective, the color management function is ineffective and the division code forcing function is effective, the CPU 41 checks the division code to confirm whether or not the designated division code is correct (step S20). In this case, as the printing request to the MFP 1 as the printer, the CPU 41 transmits the printing image data together with the division code checked as the valid division code in the division code check (step S21). Accordingly, the PC 2 can allow the MFP 1 to execute the print processing to be managed for each division. It is to be noted that the division code check will be described later in detail.

Furthermore, in a case where the above judgment is that the color management function is effective (step S17, YES), the CPU 41 judges whether or not the color mode (color designation) is set to be “monochromatic” (step S18). In a case where this judgment is that the color mode is set to be “monochromatic” (step S18, YES), the CPU 41 judges that any division code is not checked based on the operation setting information 52. That is, in a case where it is judged both of the division management function and the color management function are effective, and the color mode is “monochromatic”, the CPU 41 requests the printing without checking any division code regardless of the setting state of the division code forcing function. In this case, as the printing request to the MFP 1 as the printer, the CPU 41 transmits the printing image data without any division code (or together with the division code which is not checked) (step S21). Accordingly, the PC 2 can allow the MFP 1 to execute monochromatic print processing which is not the object of the division management in the color management function.

In addition, in a case where the above judgment is that the color mode is not set to be “monochromatic” (step S18, NO), the CPU 41 judges whether or not the division code forcing function is effective (step S19). In a case where this judgment is that the division code forcing function is ineffective (step S19, NO), the CPU 41 judges that any division code is not checked based on the operation setting information 52. That is, in a case where it is judged that both of the division management function and the color management function are effective and that the division code forcing function is ineffective, the CPU 41 requests the printing without checking any division code, even if the color designation is not “monochromatic”. In this case, as described above, as the printing request to the MFP 1 as the printer, the CPU 41 transmits the printing image data together with the division code which does not have its validity checked (step S21). Accordingly, the PC 2 can allow the MFP 1 to execute the print processing which is the object of the division management.

It is to be noted that in this case, the MFP which has received the printing request checks the division code included (or to be included) in the printing request. In a case where the check in the MFP 1 judges that the division code is invalid, the printing request turns to the pending printing job in the MFP 1. The pending printing job is executed, for example, when the user operates the operation panel 12 of the MFP 1 to input the valid division code.

Moreover, in a case where the above judgment is that the division code forcing function is effective (step S19, YES), the CPU 41 judges that the division code check be performed based on the operation setting information 52. That is, in a case where it is judged that both of the division management function and the color management function are effective and that the division code forcing function is effective, when the color designation is not “monochromatic”, the CPU 41 checks the division code to confirm whether or not the designated division code is correct (step S20). In this case, as the printing request to the MFP 1 as the printer, the CPU 41 transmits the printing image data together with the division code checked as the valid division code in the division code check (step S21). Accordingly, the PC 2 can allow the MFP 1 to execute the print processing to be managed for each division. It is to be noted that the division code check will be described later in detail.

Next, the printing set processing will be described.

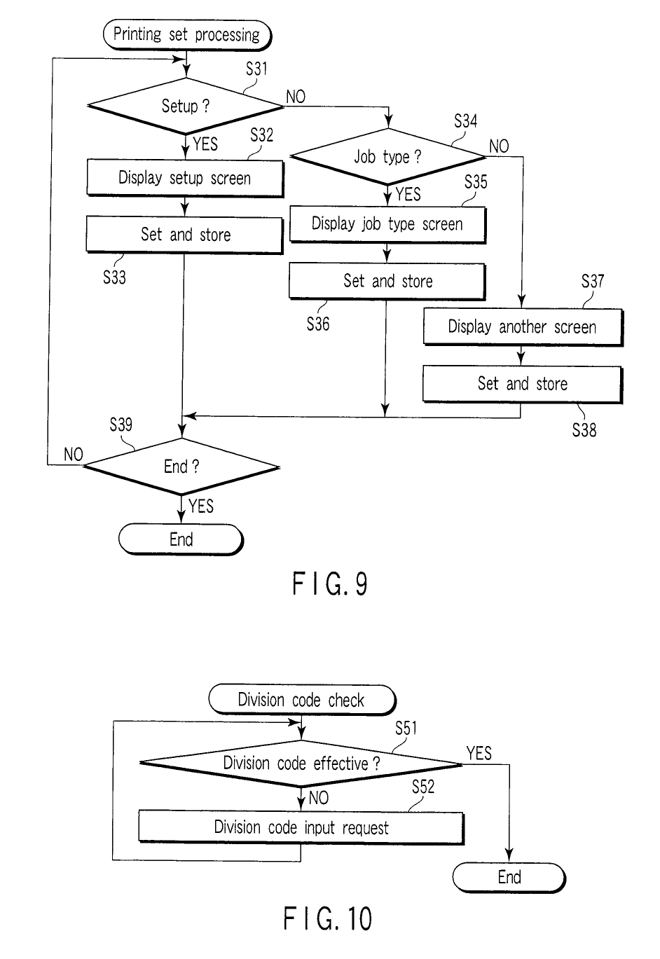

FIG. 9 is a flowchart showing a processing example of the printing set processing.

When the user instructs the print setting, the CPU 41 displays the setting screen for setting various printing functions presented by the printer driver 51. In a case where the setup screen shown in FIG. 5 is set as an initial screen of the setting screen (step S31, YES), when the user instructs the print setting, the CPU 41 displays the setup screen in the display section 46 (step S32).

In this setup screen, as described above, a printing basic setting such as the color mode is input. The setting contents input into such setting screen are stored as the print setting by pressing the “OK” key or the “apply” key (step S33). When, for example, the “OK” key is indicated in the setup screen shown in FIG. 5, the CPU 41 stores the setting contents input into the setup screen (step S33), thereby ending the set processing (step S39, YES). For example, in a case where the print setting is performed in the printing instruction screen, the CPU 41 returns the display state of the display section 46 to the printing instruction screen. When the “apply” key is indicated in the setup screen shown in FIG. 5, the CPU 41 stores the setting contents input into the setup screen, and displays the setup screen. When the “cancel” key is indicated, the CPU 41 returns the display state of the display section 46 to the previous screen without reflecting any input setting contents.

Moreover, when another setting screen is indicated by the above tab in each setting screen, the CPU 41 displays in the display section 46 the setting screen corresponding to the indicated tab. For example, in a case where the “job type” tab is indicated (step S34, YES), the CPU 41 displays in the display section 46 the job type screen shown in FIG. 6 (step S35). In this job type screen, as described above, the setting of the printing function, the division code or the like is input. The setting contents input into such setting screen are stored as the print setting by indicating the “OK” key or the “apply” key in the same manner as in the setup screen (step S36).

Furthermore, even in a case where another tab is indicated (step S34, NO), the CPU 41 displays in the display section 46 the setting screen corresponding to the indicated tab (step S37). The setting contents input in the setting screen are stored as the print setting by indicating the “OK” key or the “apply” key (step S38). It is to be noted that in a case where the “OK” key is indicated in each setting screen, the CPU 41 stores the print setting, and ends the print setting (step S39, YES).

Next, the division code check will be described.

FIG. 10 is a flowchart showing a processing example of the division code check. As shown in FIG. 10, in this division code check, the CPU 41 judges whether or not the division code designated by the user is effective (step S51). In a case where this judgment is that the division code designated by the user is not effective or that the user does not designate any division code (step S51, NO), the CPU 41 requests the user who has requested the printing job to input the division code (step S52).

As this request to the user for the input of the division code, the CPU 41 displays, for example, the popup screen in the display section 46 of the warning dialog shown in FIG. 7. In this case, the user inputs the division code into the division code input column displayed in the warning dialog, and indicates the printing key. Then, the CPU 41 returns to the above step S51 to judge again whether or not the division code is effective by the division code input into the input column. In a case where the above judgment is that the division code designated by the user is effective (step S51, YES), the CPU 41 determines the division code as the division of the printing job, and ends the division code check.

As described above, in the present embodiment, in a case where the printing request is transmitted to the MFP in which both of the division management function and the color management function are effective, when the color mode is designated to be monochromatic, the printing is requested without checking any division code. This allows the MFP 1 to execute the monochromatic print which is not the object of the division management in the color management function. When the color mode is other than the designated monochromatic mode, the division code is checked, and the printing request is transmitted together with the division code having its validity confirmed. This allows the MFP 1 to execute the print other than the monochromatic print as the object of the division management. It is to be noted that even in a case where the color mode is other than the monochromatic mode, when the division code forcing function is invalidated, any division code can be prevented from being checked in the printer driver.

According to the above embodiment, in a state in which both of the division management function and the color management function are effective, the MFP can be allowed to perform the print processing in which the color mode is designated to be monochromatic, without checking any division code. As a result, the printer driver 51 can improve operability for requesting the MFP 1 to perform the printing.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

What is claimed is:

1. An image forming control method for use in a system in which an image forming device is connected to an external device, the method comprising:
accepting, from a user in the external device, a request for image forming in the image forming device;
judging whether or not the image forming is brought into an operation mode in which the number of pages having an image formed thereon is managed for each division, each user belonging to the division, in the image forming device, in a case where the request for the image forming in the image forming device is accepted;
confirming in the external device that a division code of the user who has requested the image forming is set, in a case where the judgment is that the image forming is brought into the operation mode in which the number of the pages is managed for each division; and
transmitting the request for the image forming together with the division code from the external device to the image forming device, in a case where the confirmation confirms that the division code of the user who has requested the image forming is set.

2. The image forming control method according to claim 1, further comprising:
transmitting the request for the image forming from the external device to the image forming device, in a case where the judgment is that the image forming is brought into an operation mode in which the number of the pages is not managed for each division.

3. The image forming control method according to claim 2, wherein the operation mode to manage the number of the pages having the image formed thereon for each division to which each user belongs in the image forming device is a color mode to chromatically form the image, and the operation mode to manage the number of the pages having the image formed thereon for each division to which each user belongs in the image forming device is a monochromatic mode to monochromatically form the image.

4. The image forming control method according to claim 1, further comprising:
guiding the user to input of the division code, in a case where the confirmation does not confirm that the division code of the user who has requested the image forming is set.

5. The image forming control method according to claim 1, further comprising:
making an inquiry as to a management mode with respect to the image forming device from the external device which has accepted the request for the image forming in the image forming device,
the judging including: judging whether or not the image forming is brought into the operation mode in which the number of the pages is managed for each division based on the management mode of the image forming device included in a response to the inquiry and the operation mode of the image forming.

6. The image forming control method according to claim 5, wherein the management mode of the image forming device includes a color management mode in which only the number of the pages having an image formed thereon in a color mode is managed for each division, and
the judging includes: judging that the image forming is brought into the operation mode in which the number of the pages is managed for each division, when the image forming is brought into the color mode; and judging that the image forming is brought into the operation mode in which the number of the pages is not managed for each division, when the image forming is brought into a monochromatic mode, in a case where a response indicating the color management mode is returned from the image forming device with respect to the inquiry.

7. A program for an image forming control for use in a computer connected to an image forming device, comprising:
an accepting function which accepts, from a user, a request for image forming in the image forming device;
a judging function to judge whether or not the image forming is brought into an operation mode in which the number of pages having an image formed thereon is managed for each division, each user belonging to the division, in the image forming device, in a case where the accepting function accepts the request for the image forming in the image forming device;
a confirming function which allows the external device to confirm that a division code of the user who has requested the image forming is set, in a case where the judging function judges that the image forming is brought into the operation mode in which the number of is the pages is managed for each division; and
a transmitting function which transmits the request for the image forming together with the division code from the external device to the image forming device, in a case where the confirming function confirms that the division code of the user who has requested the image forming is set.

8. The program for the image forming control according to claim 7, wherein the transmitting function transmits the request for the image forming from the computer to the image forming device, in a case where the judging function judges that the image forming is brought into an operation mode in which the number of the pages is not managed for each division.

9. The program for the image forming control according to claim 8, wherein the operation mode to manage the number of the pages having the image formed thereon for each division to which each user belongs in the image forming device is a color mode to chromatically form the image, and
the operation mode to manage the number of the pages having the image formed thereon for each division to which each user belongs in the image forming device is a monochromatic mode to monochromatically form the image.

10. The program for the image forming control according to claim 7, further comprising:
a guiding function which guides the user to input of the division code, in a case where the confirming function does not confirm that the division code of the user who has requested the image forming is set.

11. The program for the image forming control according to claim 7, further comprising:
an inquiry function which makes an inquiry as to a management mode with respect to the image forming device, in a case where the accepting function accepts the request for the image forming in the image forming device,
the judging function judging whether or not the image forming is brought into the operation mode in which the number of the pages is managed for each division based on the management mode of the image forming device included in a response to the inquiry of the inquiry function and the operation mode of the image forming.

12. The program for the image forming control according to claim 11, wherein the management mode of the image forming device includes a color management mode in which only the number of the pages having an image formed thereon in a color mode is managed for each division, and
the judging function judges that the image forming is brought into the operation mode in which the number of the pages is managed for each division, when the image forming is brought into the color mode, and judges that the image forming is brought into the operation mode in which the number of the pages is not managed for each division, when the image forming is brought into a monochromatic mode, in a case where a response indicating the color management mode is returned from the image forming device with respect to the inquiry of the inquiry function.

13. An image forming system comprising: an image forming device; and an external device connected to the image forming device,
the external device comprising:
an accepting unit which accepts, from a user, a request for image forming in the image forming device;
a judging unit to judge whether or not the image forming is brought into an operation mode in which the number of pages having an image formed thereon is managed for each division, each user belonging to the division, in the image forming device, in a case where the accepting unit accepts the request for the image forming in the image forming device;
a confirming unit which allows the external device to confirm that a division code of the user who has requested the image forming is set, in a case where the judging unit judges that the image forming is brought into the operation mode in which the number of the pages is managed for each division; and
a transmitting unit which transmits the request for the image forming together with the division code from the external device to the image forming device, in a case where the confirming unit confirms that the division code of the user who has requested the image forming is set,
the image forming device comprising:
a printer which performs the image forming in response to the request for the image forming from the external device.

14. The image forming system according to claim 13, wherein the transmitting unit of the external device transmits the request for the image forming to the image forming device without any division code, in a case where the judging unit judges that the image forming is brought into an operation mode in which the number of the pages is not managed for each division.

15. The image forming system according to claim 14, wherein the operation mode to manage the number of the pages having the image formed thereon for each division to which each user belongs in the image forming device is a color mode to chromatically form the image, and
the operation mode to manage the number of the pages having the image formed thereon for each division to which each user belongs in the image forming device is a monochromatic mode to monochromatically form the image.

16. The image forming system according to claim 13, wherein the external device further comprises:
a guiding unit which guides the user to input of the division code, in a case where the confirming unit does not confirm that the division code of the user who has requested the image forming is set.

17. The image forming system according to claim 13, wherein the external device further comprises:
an inquiry unit which makes an inquiry as to a management mode with respect to the image forming device, in a case where the accepting unit accepts the request for the image forming in the image forming device,
the image forming device further comprises:
a setting unit which selectively sets one of various management modes; and
a response unit which returns information indicating the management mode set by the setting unit with respect to the inquiry from the external device, and
the judging unit of the external device judges whether or not the image forming is brought into the operation mode in which the number of the pages is managed for each division based on the management mode of the image forming device included in the response from the image forming device to the inquiry of the inquiry unit and the operation mode of the image forming.

18. The image forming system according to claim 17, wherein the management mode of the image forming device includes a color management mode in which only the number of the pages having an image formed thereon in a color mode is managed for each division, and
the judging unit of the external device judges that the image forming is brought into the operation mode in which the number of the pages is managed for each division, when the image forming is brought into the color mode, and judges that the image forming is brought into the operation mode in which the number of the pages is not managed for each division, when the image forming is brought into a monochromatic mode, in a case where a response indicating the color management mode is returned from the image forming device with respect to the inquiry of the inquiry unit.
